(19) United States
(12) Patent Application Publication
(10) Pub. No.: US 2005/0048154 A1
(43) Pub. Date: Mar. 3, 2005

(54) Shape replication method

(75) Inventors: Takahiro Umada, Kawasaki (JP); Mineo Moribe, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 10/951,910

(22) Filed: Sep. 29, 2004

Related U.S. Application Data
(63) Continuation of application No. PCT/JP02/03281, filed on Apr. 1, 2002.

(51) Int. Cl. B29D 11/00

(52) U.S. Cl. 425/174.4; 425/810

(57) ABSTRACT

The present invention provides a shape replication method characterized by comprising the steps of: fixing to a table a stamper having a predetermined pattern on its surface and a center opening; supplying a photocurable resin onto the patterned surface of the stamper; setting a thin-plate-like substrate having an opening smaller in diameter than the opening of the stamper on the photocurable resin so as to keep the substrate at a predetermined position relative to the stamper; applying light from above the substrate to cure the photocurable resin; and pressing a stripping member that is insertable into the opening of the stamper against a portion of the substrate surrounding its opening and extending beyond the opening of the stamper to strip off the photocurable resin integral with the substrate from the stamper.

### TECHNICAL FIELD

The present invention relates to a shape replication method, and more particularly, to a shape replication method for manufacturing a copy of an optical disk by application and curing of a UV curable resin.

### BACKGROUND ART

Conventionally, a substrate for an optical disk has been made by transferring a predetermined convex/concave pattern from a stamper having the convex/concave pattern formed on its surface. On the surface of the stamper, guide grooves (lands and grooves) and track positional data as a microscopic convex/concave pattern (also referred to as an uneven relief) are formed. The convex/concave pattern is transferred onto the substrate by, for example, a photopolymer process (also referred to as a 2P process).

In the 2P process, a copy of an optical disk is manufactured by a series of steps of: setting a stamper on a turntable, applying a liquid UV curable resin on an convex/concave pattern of the stamper, aligning and setting a substrate made of glass or the like on the resin, applying a pressure to the substrate to uniformly spread the resin, irradiating the resin with UV rays to cure the resin, and stripping the resin with the substrate from the stamper at the interface between the stamper and the resin.

In the 2P process, it is important to remove air bubbles from the resin at the spreading of the resin between the stamper and the substrate. If the air bubbles remain in the resin, land/groove pattern is partially damaged, and this may produce a defective substrate which is unable to record and reproduce information properly.

To avoid this, there has been proposed a technique of turning a whole optical disk, after the application of an UV curable resin, to remove air bubbles. In Japanese Unexamined Patent Publication No. Hei 2 (1990)-37543, for example, there is disclosed a manufacturing method of a substrate for an optical disk. In this method, after a radiation curable resin is circularly supplied on a stamper, spacers are provided between the stamper and a glass substrate to bring the resin and the substrate into contact with each other while keeping an appropriate distance between the two, and then the whole structure is turned to remove air bubbles in the resin.

Japanese Unexamined Patent Publication No. Hei 9 (1997)-44917 discloses another manufacturing method of an optical disk. In this method, a UV curable resin is applied onto a first resin substrate, and a second resin substrate is mounted on the first resin substrate. Then, the whole structure is turned at high speed to remove air bubbles contained in the resin and accelerate uniform spreading of the resin. The first and second resin substrates are then bonded together.

Further, Japanese Unexamined Patent Publication No. Hei 9 (1997)-161334 discloses a manufacturing method of an optical recording medium in which a liquid resin is dropped on a substrate (stamper) to mount a plate on the resin in alignment with the substrate, and after the whole structure is turned to uniformly spread the liquid resin between the substrate and the plate, the resin is cured so that the plate is stripped from the resin. The above-mentioned manufacturing methods show that the turning of a whole disk is effective for removing air bubbles contained in a UV curable resin.

In the above-mentioned 2P process, when forming the substrate by transferring the convex/concave pattern formed on the stamper surface, the UV curable resin needs to be stripped from the stamper after the resin is cured. This stripping step is performed by forming the stamper and the substrate to have different outside diameters, and fixing the stamper having, for example, an outside diameter smaller than that of the substrate to press a stripping member against a peripheral portion of the substrate which lies outside the stamper.

A substrate and a cured resin of a currently used optical disk have a thickness of 1.2 mm or greater and a thickness of about 10 to 20 μm, respectively. Due to this, there may be a case where air bubbles can not be completely removed, or where burrs remain on the resin at such a stripping step as described above, rendering the disk to be defective.

The thickness of the UV curable resin preferably is as thin as possible in view of complete removal of the air bubbles, reduction in the number of burrs generated, improvement of an absorption coefficient and a transmittance of light at recording and reproduction of information, and replication of the convex/concave pattern of the stamper as close as possible on a surface of the resin. Accordingly, the thickness of the substrate desirably is 1 mm or smaller so as to be thinner than that of a conventional substrate.

However, when a thin substrate is subjected to stripping by pressing the stripping member against a peripheral portion of the substrate, the substrate may be damaged owing to its strength. Further, the conventional manufacturing methods required about 15 minutes to complete the steps from the setting of the stamper on the turntable to the stripping of the substrate from the stamper. For further mass-production of the disk, a reduction in time required to complete the whole manufacturing steps has been desired.

The present invention, therefore, is made to achieve such objects as complete removal of air bubbles, thinning of a substrate, and prevention of burrs. In accordance with the present invention, there is provided a shape replication method in which the resin curing step and the stripping step of the manufacturing steps are particularly contrived to manufacture a highly productive and reliable substrate for an optical disk or the like.

### DISCLOSURE OF INVENTION

The present invention provides a shape replication method comprising the steps of: fixing to a table a stamper having a predetermined pattern on its surface and a center opening; supplying a photocurable resin onto the patterned surface of the stamper; setting a thin-plate-like substrate having an opening smaller in diameter than the opening of the stamper on the photocurable resin so as to keep the substrate at a predetermined position relative to the stamper; applying light from above the substrate to cure the photocurable resin; and pressing a stripping member that is insertable into the opening of the stamper against a portion of the substrate surrounding its opening and extending beyond the opening of the stamper to strip off the photocurable resin integral with the substrate from the stamper.

According to the invention, a highly productive and reliable thin substrate can be manufactured.

### BRIEF DESCRIPTION OF DRAWINGS

FIG. 1 is a schematic view illustrating the construction of a manufacturing apparatus according to the present invention;

FIG. 2 is a comparative view of the size of each member of the invention;

FIGS. 3(a) to 3(d) are diagrams illustrating manufacturing steps according to an embodiment of the invention;

FIGS. 4(e) to 4(g) are diagrams illustrating manufacturing steps according to the embodiment of the invention;

FIGS. 5(h) to 5(j) are diagrams illustrating disk manufacturing steps according to the embodiment of the invention;

FIG. 6 is a diagram illustrating an estimated time required for each manufacturing step of the invention;

FIG. 7 is a comparative diagram of mechanical characteristics of substrates according to the present invention; and

FIG. 8 is a graph illustrating a relationship between the thickness of a stamper and irregularites in thickness of the stamper.

### BEST MODE FOR CARRYING OUT THE INVENTION

In accordance with the present invention, there is provided a shape replication method for manufacturing a plurality of substrates such as optical disk substrates having a microscopic convex/concave pattern with high productivity and reliability. In the present invention, more specifically, a stamper having a predetermined pattern formed thereon is prepared and a liquid photocurable resin is supplied on the pattern, followed by curing of the resin to form the predetermined pattern with the resin. A conventional photocurable resin may be used as the photocurable resin.

In the present invention, the table for fixing the stamper may include a protrusion that fits with the inside diameter of the opening of the stamper, and a suction mouth and a suction member for sucking a surface of the stamper on which the predetermined pattern is not formed.

Further, the table for fixing the stamper may include a cylindrical recess at a position corresponding to the opening of the fixed stamper. The stamper and the substrate may be fixed at predetermined positions relative to each other by inserting an alignment member having a cylindrical protrusion into an opening of the substrate before the photocurable resin is cured, so that the cylindrical protrusion fits into the cylindrical recess of the table. The alignment member also has a truncated cone that fits into of the opening of the substrate.

According to the present invention, the stripping member has a cylindrical shape, and the outside diameter of the cylinder is greater than the inside diameter of the opening of the substrate and is smaller than the inside diameter of the opening of the stamper.

The step of curing the photocurable resin may include precuring for curing a part of the resin by application of light to the part of the resin for a short time, and main curing for curing the whole resin by application of light to the whole resin for a predetermined period of time after the precuring.

The outside diameters of the stamper and the substrate may be the same.

With reference to the attached drawings, the present invention will hereinafter be described in detail by way of an embodiment thereof. It should be understood that the invention be not limited to this embodiment.

[Explanation on Manufacturing Apparatus]

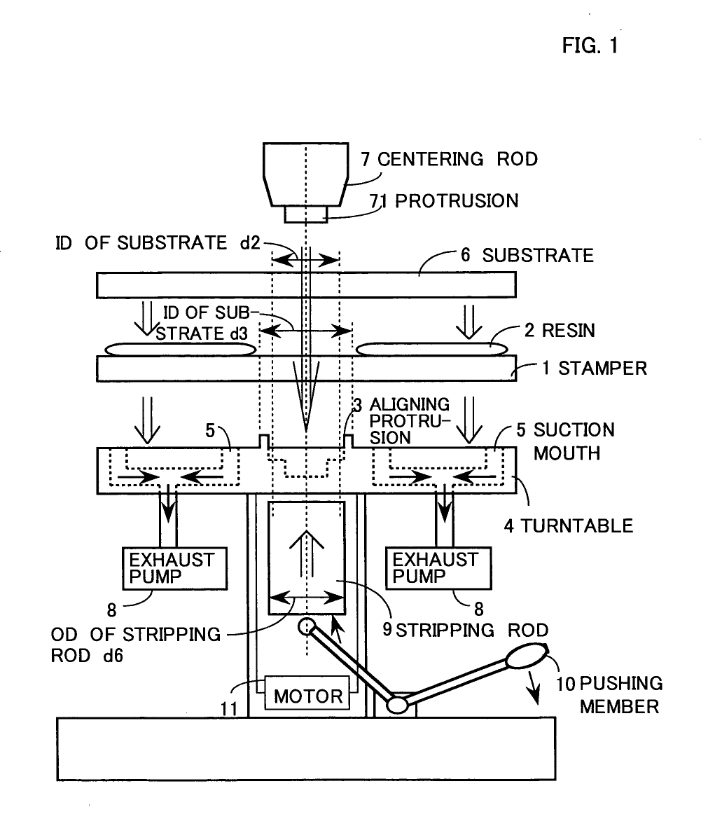

FIG. 1 shows a schematic view illustrating the construction of a manufacturing apparatus for performing the shape replication method according to the present invention.

In FIG. 1, a stamper 1 is a metal matrix having an convex/concave pattern of lands and grooves formed on one surface thereof. Onto this surface having the convex/concave pattern formed thereon, a liquid UV curable resin 2 is applied. The convex/concave pattern of the stamper 1 is then transferred to a surface of the resin 2. A glass substrate 6 serving as a matrix of an optical disk is aligned and disposed on the resin 2.

The manufacturing apparatus of the present invention mainly includes three functional blocks of a stamper fixing section, a substrate turning section, and a stripping section. The stamper fixing section is mainly constituted of an aligning protrusion 3, a turntable 4, a suction mouth 5, and an exhaust pump 8. A centering rod 7 having a protrusion 71, and an engaging portion 31 of the turntable 4 are used not for fixing the stamper, but for aligning the substrate 6 which is mounted on the stamper 1.

The engaging portion 31 is provided for fixing the centering rod. The protrusion 71 of the centering rod 7 is inserted into the engaging portion 31 so that the rod is fixed. The outside diameter of the centering rod 7 is tapered down such that it increases as it goes up. When the protrusion 71 is inserted into the engaging portion 31, the outside diameter of the centering rod 7 comes into close contact with the inside diameter d2 of the substrate, thereby determining the position of the substrate 6 in lateral direction. The aligning protrusion 3 has an outside diameter almost the same as the inside diameter d3 of the opening of the stamper 1, and engages therewith to fix the stamper 1.

The turntable 4 is a table for horizontally disposing the stamper 1. When the stamper 1 has a circular shape, the turntable 4 has a circular shape and such a size that allows the whole stamper to be mounted thereon.

In a surface of the turntable 4, there are provided a number of suction mouths 5 at predetermined positions for sucking the stamper 1 to prevent it from coming off. Inside the turntable 4, there is provided a channel for connecting the suction mouths 5 and the exhaust pump. The exhaust pump 8 is provided for fixing the stamper 1 through the channel and the suction mouths 5. The suction through the suction mouths 5 is carried out at such strength that the stamper does not warp.

The substrate turning section is a motor 11 for turning the turntable 4. After the stamper 1, the resin 2, and the substrate 6 are unitarily set on the turntable 4, the substrate turning section horizontally turns the turntable 4 to uniformly spread the resin 2 on the unevenly-patterned surface of the stamper 1.

The stripping section is mainly constituted of a stripping rod 9 and a pushing member 10. The pushing member 10 pushes up the stripping rod 9 by manual or automatic operation.

The stripping rod 9 pushes up a portion of the substrate around its inside diameter by utilizing the difference between the outside diameter d6 of the stripping rod 9 and the inside diameter d2 of the substrate 6 as will be described later. By pushing up the portion of the substrate 6 around its inside diameter, the stamper 1 and the cured resin 2 are stripped off.

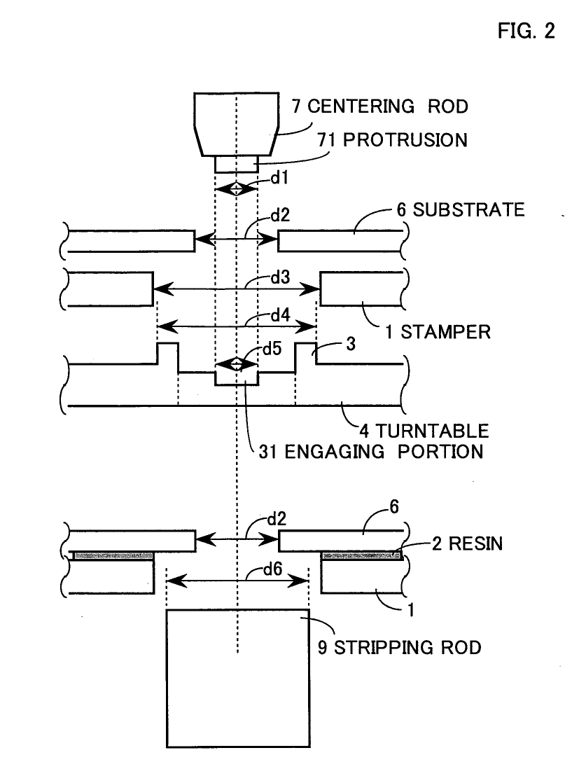

FIG. 2 shows a comparative view of the size of each member of the manufacturing apparatus and the stamper.

In FIG. 2, a reference mark d1 denotes the outside diameter of the protrusion 71 of the centering rod 7, d2 denotes the inside diameter of the center opening of the substrate 6, d3 denotes the inside diameter of the center opening of the stamper 1, d4 denotes the outside diameter of the aligning protrusion 3 of the turntable 4, d5 denotes the inside diameter of the engaging portion 31 of the turntable 4, and d6 denotes the outside diameter of the stripping rod 9.

In the present invention, the relationships of these inside diameters (ID) and outside diameters (OD) are set as follows.
ID d3 of the stamper>ID d2 of the substrate
ID d3 of the stamper≈OD d4 of the aligning protrusion
OD d1 of the centering rod protrusion≈ID d5 of the engaging portion
OD d1 of the centering rod protrusion<ID d2 of the substrate
ID d3 of the stamper>OD d6 of the stripping rod>ID d2 of the substrate

However, the outside diameter d1 of the protrusion 71 is preferably set so as to be little smaller than the inside diameter d5 of the engaging portion 31 since the protrusion 71 is inserted into the engaging portion 31.

The inside diameter d3 of the stamper 1 is preferably set so as to be little greater than the outside diameter d4 of the aligning protrusion 3 since the stamper 1 is fitted over the rim of the aligning protrusion 3.

According to the embodiment of the present invention, for example, the inside and outside diameters of each member are set as follows: the OD d1 of the protrusion 71=8 mm, the ID d2 of the substrate 6=15.0 mm, the ID d3 of the stamper 1=35.4 mm, the OD d4 of the aligning protrusion 3=35.2 mm, the ID d5 of the engaging portion 31=10 mm, and the OD d6 of the stripping rod 9=22 mm.

[Explanation on Manufacturing Steps]

Next, an explanation will be given on the manufacturing steps of a substrate for an optical disk according to the embodiment of the invention.

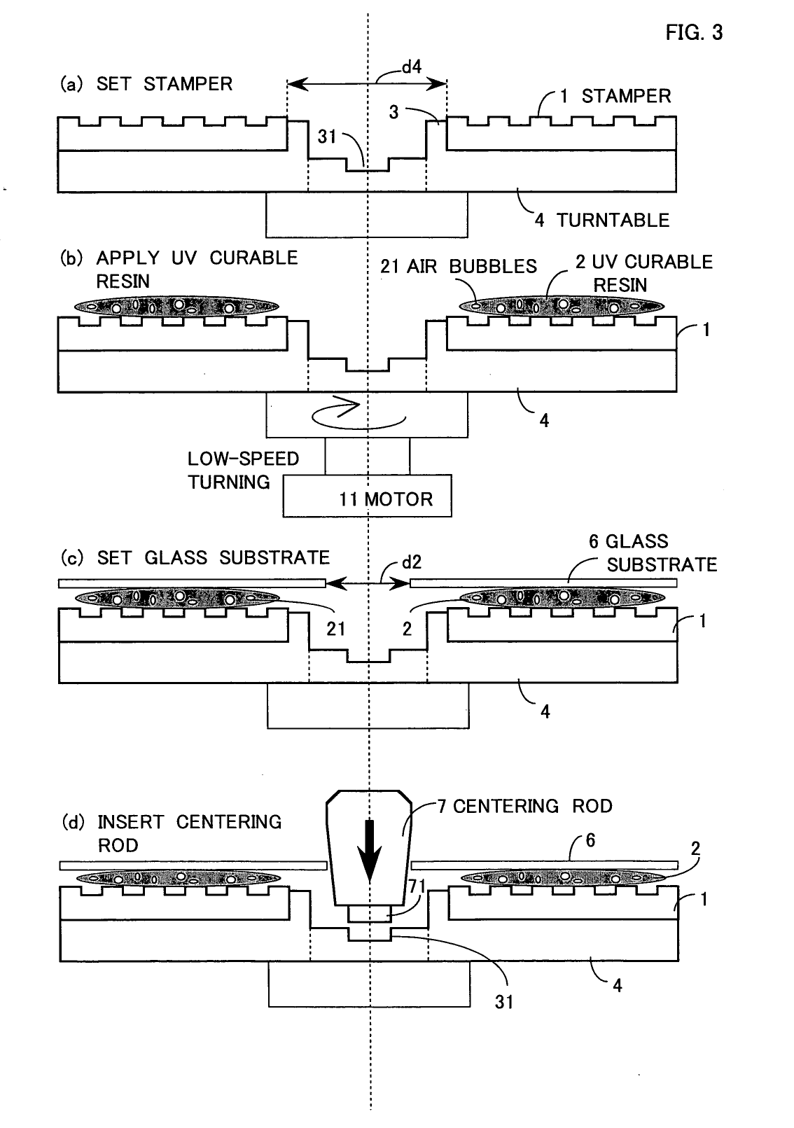

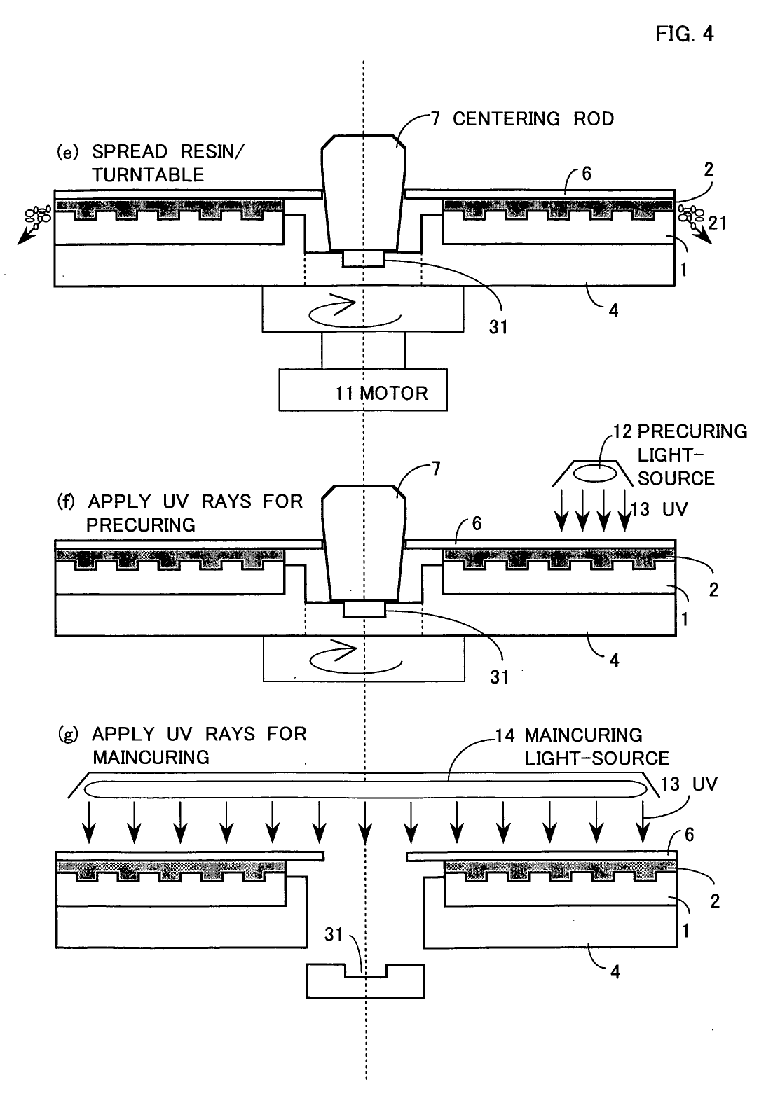

FIGS. 3(a)-3(d), 4(e)-4(g), and 5(h)-5(j) are explanatory views of the manufacturing steps of an optical disk substrate according the present invention.

In these figures, only a portion of the manufacturing apparatus of FIG. 1 near the turntable is shown, and the suction mouths 5 and the channel provided inside the turntable are omitted.

Step (a): Setting of Stamper 1

The center opening of the stamper 1 is fitted over the rim of the aligning protrusion 3 with the unevenly-patterned surface of the stamper 1 facing up, thereby to fix the stamper 1.

The stamper 1 has a circular shape and a size of: the ID d3=35.4 mm, the OD=86.0 mm, and the thickness=0.3 mm. The turntable 4 also has a circular shape and an outside diameter almost the same as that of the stamper. The turntable 4 includes the ring-shaped aligning protrusion 3 with the rim having a diameter of 35.4 mm and a width of about 3 mm.

In case the stamper 1 is not completely fixed just by fitting over the aligning protrusion 3, the stamper 1 is preferably vacuum-adhered to the turntable 4 via the suction mouths 5 shown in FIG. 1 to prevent the stamper 1 from vibrating in response to the turning in the subsequent steps. The stamper is generally made of metal and if it is magnetic, it may be magnetically adhered to the turntable 4 by attaching a magnet thereto.

Step (b): Application of UV Curable Resin

While the turntable 4 is turned at a low speed of about 30 rpm, the UV curable resin 2 of such a predetermined amount that covers the entire pattern of the stamper 1 is applied in a ring form. The UV curable resin may be, for example, a photopolymer resin used in the conventional methods. At the application, the resin 2 is in liquid state and contains a large number of air bubbles 21.

Step (c): Setting of Glass Substrate

The glass substrate 6 is set on the UV curable resin 2. The glass substrate 6 has an ID d2 of 15.0 mm, an OD of 86.0 mm, and a thickness of 0.6 mm. Since the present invention includes the under-mentioned UV ray application step and stripping step, there can be provided a highly reliable optical disk with less warp even when the substrate 6 smaller in thickness than conventional substrates is used. When the substrate 6 is set on the resin 2, the resin 2 spreads little in the horizontal direction due to the weight of the substrate 6, but the air bubbles still remain in the resin.

Step (d): Insertion of Centering Rod

To accurately align the relative positions of the substrate 6 and the stamper 1, the centering rod 7 is inserted into the center opening of the substrate 6 so that the protrusion 71 of the centering rod 7 is fitted into the engaging portion 31 of the turntable 4.

The protrusion 71 in cylindrical shape has an outside diameter d1 of about 8 mm and a height of about 5 mm. The engaging portion 31 has almost the same shape as the protrusion 71. As described above, the side of the centering rod 7 is tapered down so that the outside diameter of the rod becomes greater as it goes up. By tightly engaging a predetermined position of the side of the rod 7 and the substrate 6, the position of the substrate 6 is adjusted, and the relative positions of the stamper 1 and the substrate 6 are accurately determined.

Step (e): Turning and Spreading of Resin

To spread the UV curable resin 2 and remove the air bubbles 21 remaining inside the resin 2, the motor 11 is driven to turn the turntable 4 at a high speed of 2,400 rpm. The turning time is not particularly limited as long as the resin 2 is sufficiently spread over the stamper 1 and the air bubbles 21 are sufficiently removed. The turning time may be, for example, about 5 seconds. This turning of the turntable 4 uniformly spreads the resin 2 over the entire pattern of the stamper 1 and releases the air bubbles 21 to the outside from the rim of the stamper 1.

Step (f): Irradiation with UV Rays for Precuring

From above the substrate 6, UV rays 13 having an intensity of 80 w/cm² are applied for about 5 seconds using a precuring light-source 12 to cure a part of the resin 2. This step is required to prevent the stamper 1 and the substrate 6 from being misaligned when the stamper 1 needs to be removed and transferred for the subsequent step of applying UV rays for main curing.

However, when the subsequent main curing and stripping processes are performed while the stamper 1 is left on the same turntable 4, such a precuring step can be omitted. In that case, the time required for completing the entire steps is shortened since no time is required for precuring (about 5 seconds). In other words, when the manufacturing steps (a) to (i) can be carried out using the same turntable 4, the step (f) is not necessary.

Step (g): Irradiation with UV Rays for Main Curing

First, the stamper 1 integrated with the resin 2 and the substrate 6 by precuring are removed from the turntable 4 and then set on a main-curing table. Alternatively, the centering rod 7 is pulled out, and a center portion of the turntable 4 including the engaging portion 31 is detached from the turntable 4 so that the stripping rod 9 located at the lower portion of the apparatus can be used.

To completely cure the resin 2, UV rays 13 having an intensity of about 160 w/cm² are applied from above the substrate 6 for about 8 seconds using a main curing light-source 14. This solidifies the resin 2 and removes the air bubbles 21, whereby a reversed convex/concave pattern of the stamper 1 is accurately transferred.

Step (h): Pushing Up of Stripping Rod

First, the stamper 1 is firmly fixed to the turntable 4 by vacuum suction from the exhaust pump 8.

The pushing member 10 located at the lower portion of the apparatus is operated to push up the stripping rod 9. The stripping rod 9 is then pushed into an opening provided within the aligning protrusion 3 of the turntable 4, and touches a portion of the substrate 6 around its inside diameter. The stripping rod 9 pushes the substrate 6 up since the outside diameter d6 of the stripping rod 9 is greater than the inside diameter d2 of the substrate 6 as described above.

As the stripping rod 9 is pushed up, the stamper 1 and the cured resin 2 are stripped off as shown in step (i) since the bonding between the substrate and the resin is stronger than that between the stamper and the resin. The stripping of the stamper and the resin only takes about 3 seconds.

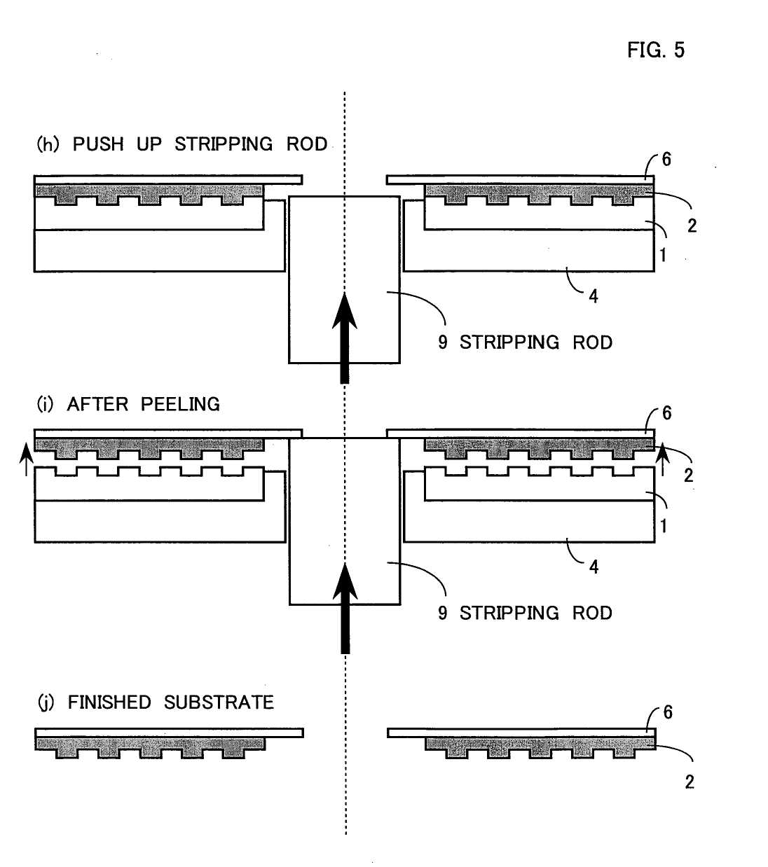

Through the above-mentioned steps, there is completed an optical disk in which the unevenly patterned resin 2 is formed on the substrate 6 as shown in step (j) of FIG. 5.

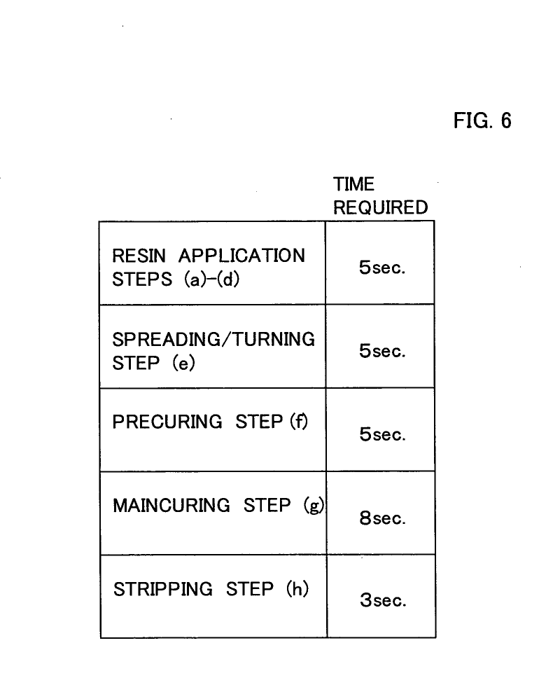

A table showing the time required for each of the above-mentioned steps is shown in FIG. 6. In the table, a resin application process signifies the steps (a) to (d). The time required for the respective steps are: the resin application steps (a) to (d)=5 sec.; the spreading/turning step (e)=5 sec.; the precuring step (f)=5 sec.; the main curing step (g)=8 sec.; and the stripping step (h)=3 sec. This means that one optical disk can be manufactured in about 26 seconds at minimum.

Even if the time required for the transfer of the stamper, which is prior to the main curing step (g), is estimated at about 30 seconds, one optical disk can be completed in about a minute.

The optical disk substrate according to the present invention includes the glass substrate 6 and the cured resin 2 having a thickness of 0.595 mm and about 0.005 mm, respectively. The disk as a whole has a thickness of about 0.6 mm which is thinner than the thickness of the conventional disk substrates.

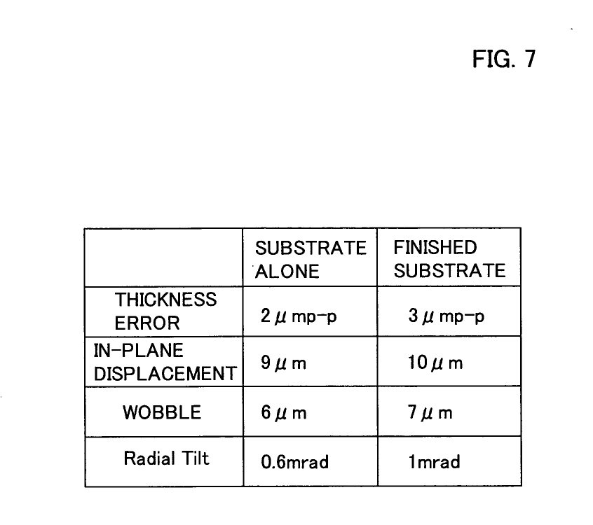

Such a thin disk substrate needs to have a sufficient strength (mechanical characteristics) and no warps. As shown in FIG. 7, the optical disk substrate of the present invention shows values almost the same as the mechanical characteristic parameters of the glass substrate by itself. This indicates that the disk substrate according to the present invention has a sufficient strength.

In the present invention, the stamper 1 is fixed to the turntable 4 by suction. However, the stamper may be warped depending on the strength of suction. A warp in the stamper results in a warp (irregularities in thickness) in the optical disk substrate to be manufactured. This eventually causes an aberration of the optical disk, and may further make the disk to be defective.

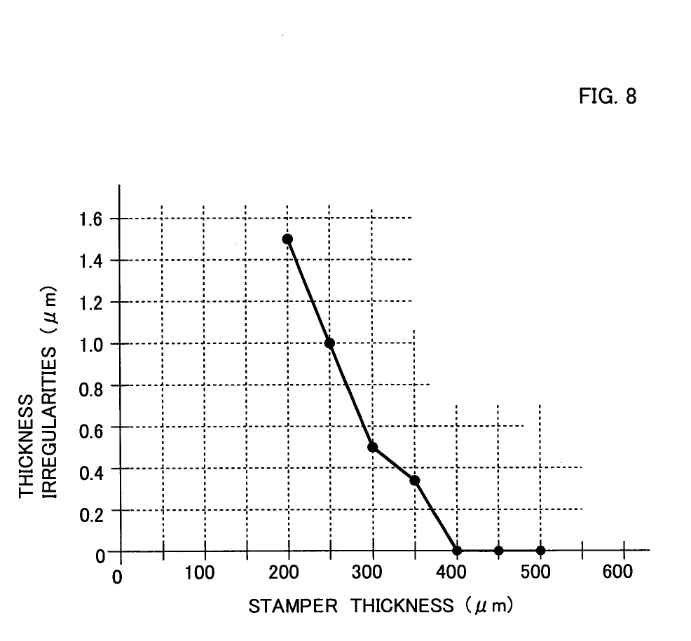

Conventionally, a stamper having a thin thickness of about 300 μm has been used as the stamper 1. However, it is found that the use of a stamper having a thickness of 400 μm or greater nearly eliminates the thickness irregularities of the optical disk substrate to be manufactured as shown in FIG. 8.

Thus, the stamper 1 preferably has a thickness of 400 μm or greater to manufacture a highly reliable substrate with high yield.

Effect of the Invention

According to the present invention, a highly productive and reliable substrate smaller in thickness than the conventional substrate can be manufactured with a reduction in thickness irregularities generated at manufacturing thereof.

1. A shape replication method characterized by comprising the steps of:
fixing to a table a stamper having a predetermined pattern on its surface and a center opening;
supplying a photocurable resin onto the patterned surface of the stamper;
setting a thin-plate-like substrate having an opening smaller in diameter than the opening of the stamper on the photocurable resin so as to keep the substrate at a predetermined position relative to the stamper;
applying light from above the substrate to cure the photocurable resin; and
pressing a stripping member that is insertable into the opening of the stamper against a portion of the substrate surrounding its opening and extending beyond the opening of the stamper to strip off the photocurable resin integral with the substrate from the stamper.

2. A shape replication method according to claim 1, characterized in that the table for fixing the stamper comprises a protrusion that fits with the inside diameter of the opening of the stamper, and a suction mouth and suction member for sucking a surface of the stamper on which the predetermined pattern is not formed.

3. A shape replication method according to claim 1, characterized by inserting an alignment member into the opening of the substrate, before the photocurable resin is cured, for fixing the stamper and the substrate at predetermined positions relative to each other,
wherein the table for fixing the stamper comprises a cylindrical recess at a position corresponding to the opening of the fixed stamper, and the alignment member has a cylindrical protrusion adapted to fit into the recess of cylindrical recess of the table and a truncated cone adapted to fit into the inside diameter of the opening of the substrate, so that the cylindrical protrusion fits into the cylindrical recess when the alignment member is inserted into the opening of the substrate.

4. A shape replication method according to claim 1, characterized in that the stripping member is a cylinder having an outside diameter greater than the inside diameter of the substrate and smaller than the inside diameter of the stamper.

5. A shape replication method according to claim 1, characterized in that the step for curing the photocurable resin comprises precuring for applying light to a part of the photocurable resin for a short time to cure the part of the resin, and main curing for applying, after the precuring, light to the whole resin for a predetermined period of time to cure the whole resin.

6. A shape replication method according to claim 1, characterized in that the stamper and the substrate have the same outside diameter.

7. A shape replication apparatus characterized by comprising:
a stamper fixing portion for fixing a stamper having a predetermined pattern formed on its surface and a center opening;
a resin supplying portion for supplying a photocurable resin onto the patterned surface of the stamper;
a substrate setting portion for setting a thin plate-like substrate having an opening smaller in diameter than the opening of the stamper on the photocurable resin so as to keep the substrate at a predetermined position relative to the stamper;
a light applying portion for applying light from above the substrate to cure the photocurable resin; and
a stripping portion for pressing a stripping member that is insertable into the opening of the stamper against a portion of the substrate surrounding its opening and extending beyond the opening of the stamper to strip off the photocurable resin integral with the substrate from the stamper.

8. A shape replication apparatus according to claim 7, wherein the stamper fixing portion comprises a protrusion adapted to fit with the inside diameter of the opening of the stamper, a suction mouth for sucking a surface of the stamper on which the predetermined pattern is not formed, and a suction member for sucking the stamper by vacuum suction through the suction mouth.

9. A shape replication apparatus according to claim 7, further comprising a turning portion for horizontally turning the stamper fixing portion.

10. A shape replication apparatus according to claim 7, characterized in that the stamper fixing portion comprises a cylindrical recess at a portion corresponding to the opening of the fixed stamper, and
the apparatus further comprises an alignment member having a cylindrical protrusion and a truncated cone,
wherein the cylindrical protrusion fits into the cylindrical recess and the periphery of the truncated cone abutting the opening of the substrate when the alignment member is inserted into the opening of the substrate set on the photocurable resin.
